(19) United States
(12) Patent Application Publication
(10) Pub. No.: US 2026/0225859 A1
(43) Pub. Date: Aug. 6, 2026

(54) LIFTING SYSTEM FOR LIFTING A TOWER SECTION WITH A WEDGE FLANGE

(71) Applicant: Siemens Gamesa Renewable Energy A/S, Brande (DK)

(72) Inventors: Shruthi Adihalli Siddaligmurthy, Bangalore (IN); Guru Anandan, Puliyankannu, Ranipet (IN); Sachin H M, Shimoga, Karnataka (IN); Boerge Hansen, Hedensted (DK); Marc Artur Sotos Richard, Vejle (DK); Shiva Rahul Tummala, Poranki, Vijayawada (IN); Vidyasagar Venkatachalam, Authoor, Tuticorin Dist, Tamil Nadu (IN)

(21) Appl. No.: 19/155,657

(22) PCT Filed: Feb. 19, 2024
(86) PCT No.: PCT/EP2024/054165

§ 371 Date: Aug. 12, 2025

(30) Foreign Application Priority Data
Feb. 17, 2023 (EP) 23157192.8

(51) Int. Cl. B66C 1/10

(52) U.S. Cl. CPC B66C 1/108

(57) ABSTRACT

A lifting system for lifting a wedge tower segment of a wedge tower of a wind turbine, including a first lifting assembly for engaging with a male side of a flange of the wedge tower segment and a second lifting assembly for engaging with a female side of a flange of the wedge tower segment The first lifting assembly includes a first lifting bracket with a plurality of first fixation means and a first hinge interface for attaching the first lifting assembly to an adapter of a crane. The first fixation means includes a plurality of first fixation bolts for being inserted into wedge slots of the male side of the flange of the wedge tower segment for fixing the first lifting bracket to the flange. The first hinge interface has an offset to the first lifting bracket in a radial direction of the wedge tower segment.

### CROSS REFERENCE TO RELATED APPLICATIONS

This application is a national stage of PCT Application No. PCT/EP2024/054165, having a filing date of Feb. 19, 2024, which claims priority to EP Application No. 23157192.8, having a filing date of Feb. 17, 2023, the entire contents both of which are hereby incorporated by reference.

### FIELD OF TECHNOLOGY

The following relates to a lifting system for lifting a wedge tower segment of a wedge tower of a wind turbine. A wedge tower segment is considered a tower section with a wedge flange for a tower of a wind turbine.

### BACKGROUND

It is known that wind turbine tower segments shall be transported horizontally. To prevent rotational movements of the wind turbine tower segments during transportation, especially for driving through curves or when strong side winds occur, supportive studs are used to hold the wind turbine tower segment in place on a loading area of a trailer. To fasten the wind turbine tower segment to the stud and the trailer, additional tension belts can be used.

At an installation site of the wind turbine, the tower segment has to be erected to an upright position and placed onto an installation area of a foundation or a previously installed wind turbine tower segment. Subsequently, the wind turbine tower segment is fixed to the installation area by fixation means, such as nuts and bolts or the like.

Common wind turbine tower segments comprise a tubular main body with two open sides. For fixation of the wind turbine tower segment to the foundation or another wind turbine tower segment, an L-shaped or a T-shaped flange is arranged on the open sides of the main body. For inserting the fixation bolts, the flanges comprise a plurality of through bores.

To move the wind turbine tower segment onto the trailer and from the trailer to the installation position, lifting systems are used. Common lifting systems for this purpose comprise a first lifting assembly for engaging with a first open end of the wind turbine tower section and a second lifting assembly for engaging with a second open end of the wind turbine tower section.

The first lifting assembly comprises a first lifting bracket with a plurality of first bores for being aligned with the through bores of the flange of a first side of the wind turbine tower segment. Thus, the first lifting bracket can be fixed to the wind turbine tower segment by the use of fixation bolts and nuts. The first lifting bracket further has a first hinge bore for being pivotably connected with a spreader beam for engaging with a hook of a crane. Usually, the first lifting assembly comprises two first lifting brackets, being arranged on opposite locations of the first side, wherein the spreader beam is interposed between the two first lifting brackets. By these means, a rotational movement of the wind turbine tower segment during handling by the crane can be avoided or at least reduced.

The second lifting assembly can be configured with only one second lifting bracket and an upending hook instead of a spreader beam. The second lifting bracket is configured for engaging an inner surface and a second side of the wind turbine tower segment. By these means, the horizontal handling of the wind turbine tower segment is improved. When the wind turbine tower segment is tilted into the upright position, the second lifting device can be removed from the wind turbine tower segment.

Known lifting systems have the disadvantage that the usage with wedge tower segments of a wedge tower of a wind turbine is not possible with the existing configuration. This has basically two reasons. Wedge tower segments have fixation bores with a radial extension, wherein the bores of the flanges of the standard wind turbine tower segments have an axial extension. Moreover, fixation bores of wedge towers often have an oval cross-section. With standard fixation means, there could be a relative movement between the lifting system and the wind turbine tower segment, which can potentially complicate the alignment of the wind turbine tower segment during the installation process and can even cause severe damage to the wind turbine tower segment.

### SUMMARY

An aspect relates to a lifting system for lifting a wedge tower segment of a wedge tower of a wind turbine which provides for a secure handling of a wedge tower segment during an alignment process and avoids a relative movement between the lifting system and the wedge tower segment in a simple and inexpensive manner.

According to embodiments of the invention, the aspect is achieved by a lifting system for lifting a wedge tower segment of a wedge tower of a wind turbine. Wedge tower segments comprise a flange with a male side and a flange with a female side, wherein the male side comprises a plurality of wedge slots. The lifting system comprises a first lifting assembly for engaging with a male side of a flange of the wedge tower segment and a second lifting assembly for engaging with a female side of the flange of the wedge tower segment. The first lifting assembly comprises a first lifting bracket with a plurality of first fixation means for fixing the first lifting bracket to the male side of the flange wedge tower segment and a first hinge interface for attaching the first lifting assembly to an adapter of a crane. The first fixation means comprises a plurality of first fixation bolts for being inserted into wedge slots of the male side of the flange of the wedge tower segment for fixing the first lifting bracket to the flange. According to embodiments of the invention, the first hinge interface has an offset to the first lifting bracket in a radial direction of the wedge tower segment.

Tower segments with the following properties are generally known and denoted as “wedge tower segments”. The wedge tower segment to be handled by the lifting system has a flange with a male side and a flange with a female side, wherein the flanges are located on opposite face sides of the wedge tower segment. Both flanges are connected to a wall of the wedge tower segment. For center wedge tower segments, the male side is configured to be inserted into a female side of an adjacent, e.g., upper or lower, wedge tower segment, and the female side is configured to receive a male side of an adjacent, e.g., lower or upper, wedge tower segment. Thus, two wedge tower segments can be paired. For increased stability, the male side can comprise an annular ring for engaging the female side at an end position of the pairing movement. In that end position, wedge slots of the male side are aligned with wedge slots of the female side. By inserting fixation bolts into the aligned wedge slots, especially in a radial direction with respect to the wedge tower segments, and securing the fixation bolts with fixation nuts, the two wedge tower segments can be fixed together. An advantage of this design is that no barrel nuts are needed and, therefore, the assembly is facilitated.

For engaging the female side of the wedge tower segment, the lifting system comprises the second lifting assembly. The second holding assembly may be configured like lifting assemblies for engaging female sides of wedge tower segments known from the present state in the art.

For engaging and holding the male side of the wedge tower segment, the lifting system comprises the first lifting assembly with the first lifting bracket. In an embodiment, the first lifting bracket is made of steel or the like. The first lifting bracket comprises the plurality of first fixation means. The first fixation means comprises a plurality of first fixation bolts and first fixation nuts for fixing the lifting bracket to the male side. The first lifting bracket comprises first fixation bores for being aligned with the wedge slots of the male side. The first fixation bolts each comprise a first longitudinal axis, wherein the first longitudinal axes are arranged coaxially with the first fixation bores.

Alternatively, the first fixation bolts can be fixed to the lifting bracket, e.g., by welding. Thus, during the alignment of the lifting bracket with the male side, the first fixation bolts can be inserted into the wedge slots and secured by the fixation nuts in an end position of the lifting plate.

In an embodiment, the fixation means are configured in a way that two first fixation bolts are assigned to one wedge slot. By these means, a secure connection of the lifting bracket to the male side of the wedge tower segment can be achieved.

For attaching the first lifting assembly to an adapter of a crane, the first lifting bracket comprises the first hinge interface. Within the limits of embodiments of the invention, a first hinge interface can be considered an attachment device, e.g., a loop, hook, bar, rod or the like, for engaging a hook of the crane for lifting the wedge tower segment. According to embodiments of the invention, the first hinge interface has an offset to the first lifting bracket in a radial direction of the wedge tower segment. This means that the first hinge interface is configured such that the hook of the crane, which is engaged with the first hinge interface, is either closer to a center axis of the wedge tower segment than the first lifting bracket or further away from the center axis than the first lifting bracket. It is desirable that the first hinge interface is configured such that the distance of the hook of the crane, which is engaged with the first hinge interface, to the center axis is closer to the distance of the flange to the center axis than to the distance of the first lifting bracket to the center axis. Since these parts have a thickness, it is desirable that all these distances are considered from a middle of the thickness of each part to the center axis.

Furthermore, it is desirable that the first lifting assembly comprises two first lifting brackets for being attached to opposite ends of the male side of the wedge tower segment. Thus, orientation stability of the wedge tower segment during handling at the installation site can be improved.

A lifting system according to embodiments of the invention has the advantage over conventional lifting systems that in a simple and inexpensive way, wedge tower segments can be handled. By providing the first lifting bracket with the first hinge interface, a coupling to the crane can be easily and securely provided. Furthermore, due to the offset of the first hinge interface to the first lifting bracket, the fixation means have an advantageous orientation within the load path when lifting the wedge tower segment. By this arrangement, a reduced torque on the fixation means, the wedge slots and the first hinge interface can be achieved. Thus, the lifespan of the first lifting bracket and the first fixation means can be extended. Beyond that, damages to the wedge slots can be prevented better.

According to an embodiment of the invention, the first hinge interface is configured that, in a state mounted to the male side of the flange, the first hinge interface is arranged in line with the flange at the male side. This means that the offset of the first hinge interface is such that the adapter of the crane, e.g., a hook or the like, which is engaged with the first hinge interface, is located at a face side of the male side. A projection of the flange parallel to the center axis would intersect with the adapter. It is further desirable that a projection of a center line of the flange would intersect with a center line of the first hinge interface, wherein the center line of the first hinge interface is considered the engagement center of the adapter of the crane. This has the advantage that in a simple and inexpensive way, a secure handling of the wedge tower segment can be improved and lifetime of some components of the lifting system can be increased. Moreover, damages to the wedge slots can be prevented better.

In an embodiment, the first hinge interface comprises a cylindrical interface body. As an example, the interface body of the first hinge interface can be configured as a bar, rod or the like. Within the limits of embodiments of the invention, the cylindrical interface body can have abrupt and/or gradient changing diameters. This has the advantage that in a simple and inexpensive way, a secure handling of the wedge tower segment can be improved and lifetime of some components of the lifting system can be increased. Moreover, damages to the wedge slots can be prevented better.

It is desirable according to embodiments of the invention that the cylindrical interface body has a shoulder and/or form-fit portion for keeping the adapter of the crane in line with the cylindrical interface body. A shoulder could be designed as an abrupt or gradient changing diameter of the cylindrical interface body. A form-fit portion can be designed as a circumferential rim, ripple or the like. By these means, the cylindrical interface body is configured such that a relative position of the adapter of the crane to the cylindrical interface body can be limited. This has the advantage that in a simple and inexpensive way, a secure handling of the wedge tower segment can be improved and lifetime of some components of the lifting system can be increased. Moreover, damages to the wedge slots can be prevented better.

In an embodiment, the cylindrical interface body is arranged between the first lifting bracket and an auxiliary bracket, wherein the auxiliary bracket comprises a retaining portion for retaining the auxiliary bracket against the first lifting bracket. This can include a configuration where the cylindrical interface body penetrates the first lifting bracket and/or the auxiliary lifting bracket. Thus, at least a part, a longest part, of the cylindrical interface body is arranged between the first lifting bracket and an auxiliary bracket. In an embodiment, the auxiliary bracket has a smaller base area than the first lifting bracket. In an embodiment, the auxiliary bracket is configured such that in the mounted state, the auxiliary bracket is located spaced apart from the flange along the center axis of the wedge tower segment. In other words, it is desirable that in radial direction of the wedge tower segment, there is no overlap between the flange and the auxiliary bracket. However, there is an overlap between the flange and the first lifting plate. In an embodiment, the retaining portion is configured as a bracket between the first lifting bracket and the auxiliary bracket. The retaining portion can be attached to the first lifting bracket and the auxiliary bracket by welds, screws or the like. This has the advantage that in a simple and inexpensive way, a secure first hinge interface is provided for attaching the adapter of the crane.

Alternatively, the cylindrical interface body is arranged between two holding bars, wherein the holding bars are connected to the first lifting bracket. In an embodiment, the holding bars are connected to the first lifting bracket by another cylindrical interface body, a bearing, a bushing or the like. With a bearing or a bushing, a relative rotation of the holding bars to the first lifting bracket is promoted. Thus, friction between the first lifting bracket and the holding bars can be reduced, which is advantageous when handling the wedge tower segment by a crane, e.g., when positioning the wedge tower segment in an upright position at the installation site. This has the advantage that in a simple and inexpensive way, a secure first hinge interface is provided for attaching the adapter of the crane.

Further, the holding bars are mutually connected by a cross bar. It is desirable that the cross bar is attached to the holding bars by welds, screws or the like. In an embodiment, the cross bar is arranged in a middle section of the holding bars, thus forming an “H”. A connection to the first lifting bracket is on one side of the cross bar, and the cylindrical interface body is arranged on the opposite side of the cross bar. This has the advantage that in a simple and inexpensive way, a secure first hinge interface is provided for attaching the adapter of the crane.

According to a further development of embodiments of the invention, a lifting system can provide that the first fixation means comprises a plurality of spacer blocks for infilling the wedge slots, wherein the spacer blocks comprise bores for the first fixation bolts. The spacer blocks are made of steel. In an embodiment, the spacer blocks are configured for completely filling the wedge slots. Common wedge slots comprise an oval cross-section. Therefore, it is desirable that the spacer blocks comprise an oval cross-section as well. In an embodiment, the spacer blocks have a length equal to the length of the wedge slots. Thus, a force transmission between the spacer blocks and the wedge slots is improved due to a reduced mutual surface pressure. This has the advantage that in a simple and inexpensive way, a secure handling of the wedge tower segment can be improved.

It is desirable according to embodiments of the invention that the first fixation means comprises a plurality of first clamping plates for clamping the flange of the wedge tower segment in between the first lifting bracket and the first clamping plates. This configuration is desirable in combination with spacer blocks as described above. The first clamping plates are made of steel, a comparatively hard metal or the like. By fastening the fixation nuts to the first fixation bolts, the clamping pressure between the first clamping plates and the first lifting bracket against the wall of the male side of the wedge tower segment can be increased. Thus, the risk of a tilt action of the first lifting bracket and the load onto the wedge slots can be reduced. This has the advantage that in a simple and inexpensive way, a secure handling of the wedge tower segment can be improved.

The first fixation means comprises a first dampening plate at the first clamping plates for being interposed between the first clamping plate and the wedge tower segment. Preferably, the first dampening plate comprises bonded foam, rubber or the like. By the first dampening plate, continuous and gentle contact with the wedge tower segment can be achieved, and damages to the wedge tower segment can be avoided. This has the advantage that in a simple and inexpensive way, a secure handling of the wedge tower segment can be improved.

In an embodiment of the invention, the first fixation means comprises a plurality of second clamping plates at the first lifting bracket for clamping the male side of the wedge tower segment in between the second clamping plates and the first clamping plates. The second clamping plates are made of aluminum, a comparatively soft metal or the like. Thus, when increasing the clamping pressure, the second clamping plate can be slightly deformed. This prevents damage to the other components and provides for a secure clamping action with reduced load to the wedge slots when handling the wedge tower segment. This has the advantage that in a simple and inexpensive way, a secure handling of the wedge tower segment can be improved.

In an embodiment, the first fixation means comprises a second dampening plate at the second clamping plates for being interposed between the second clamping plate and the wedge tower segment. In an embodiment, the second dampening plate comprises bonded foam, rubber or the like. By the second dampening plate, continuous and gentle contact with the wedge tower segment can be achieved, and damages to the wedge tower segment can be avoided. This has the advantage that in a simple and inexpensive way, a secure handling of the wedge tower segment can be improved.

It is desirable according to embodiments of the invention that the second lifting assembly comprises a first holding plate for engaging a face side of the female side of the flange of the wedge tower segment, a second holding plate for engaging an inner wall of the female side of the flange and a hinge bore for attaching the second lifting assembly to the crane. The first holding plate is configured to engage with the face side of the flange. Such face side can be provided, e.g., by an L-shaped or a T-shaped flange. In an embodiment, the hinge bore extends through the first holding plate. The first holding plate may comprise a third dampening plate for gently engaging the wedge tower segment. Furthermore, the second holding plate may comprise a fourth dampening plate for gently engaging the wedge tower segment. Moreover, the second lifting assembly may comprise second fixation means for fixing the first holding plate to the female side. This has the advantage that in a simple and inexpensive way, a secure handling of the wedge tower segment can be improved.

It is further desirable that the second lifting assembly comprises an upending hook, pivotably arranged at the hinge bore. For improving a pivoting action of the upending hook, a bushing, bearing or the like can be provided at the hinge bore. The bushing can be welded at the hinge bore. The bearing can be pressed into the hinge bore. In an embodiment, the bushing or bearing extends through the hinge bore, completely. Moreover, the bushing or bearing may protrude from one or both sides of the second hinge bore. With the bushing or bearing, friction between the first holding plate and a further assembly for connecting the crane to the second lifting assembly can be reduced during tilting of the wedge tower segment, e.g., when positioning the wedge tower segment in an upright position at the installation site. This has the advantage that in a simple and inexpensive way, a secure handling of the wedge tower segment can be improved.

### BRIEF DESCRIPTION

Some of the embodiments will be described in detail, with references to the following Figures, wherein like designations denote like members, wherein:

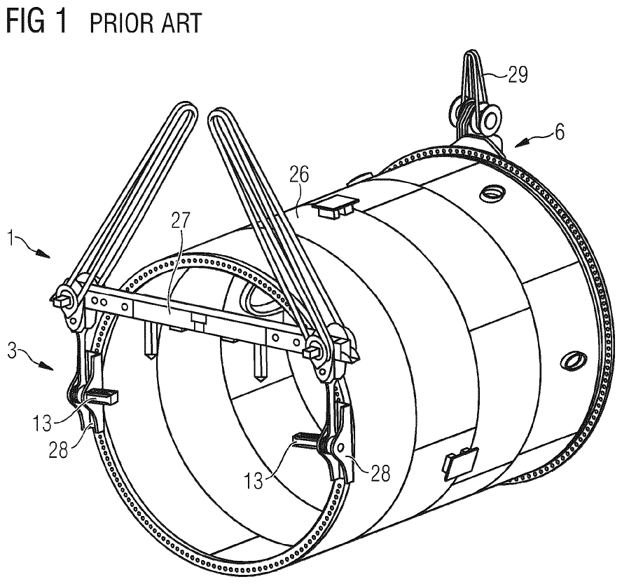

FIG. 1 shows a schematic perspective view of a lifting system with a standard tower segment according to the prior art,

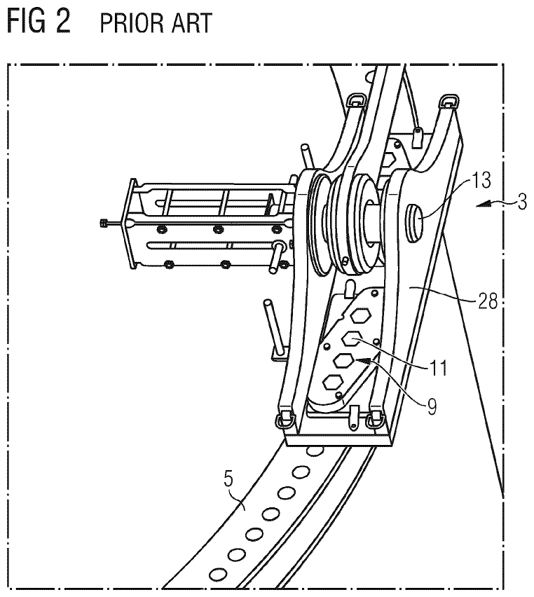

FIG. 2 shows a schematic first detail view of the lifting system of FIG. 1,

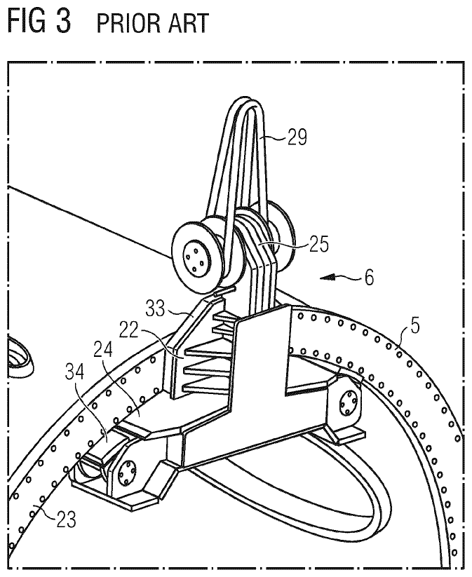

FIG. 3 shows a schematic second detail view of the lifting system of FIG. 1,

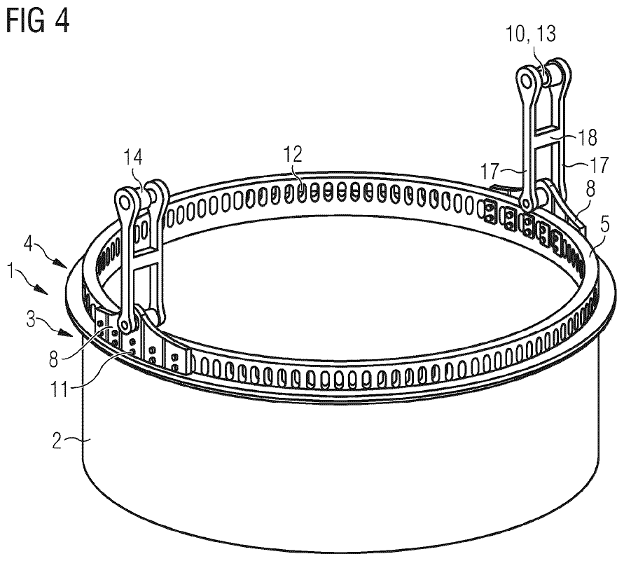

FIG. 4 shows a schematic perspective detail view of a lifting system with a male side of a wedge tower segment according to a first embodiment of the invention,

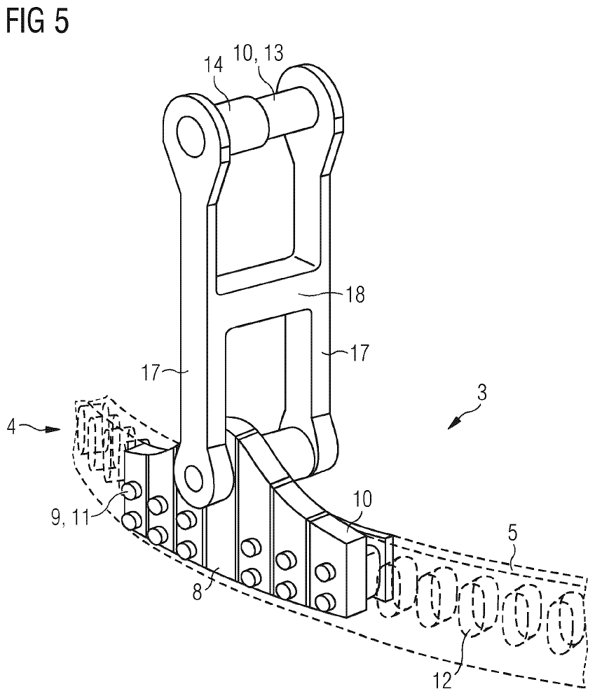

FIG. 5 shows a schematic first detail view of the lifting system of FIG. 4,

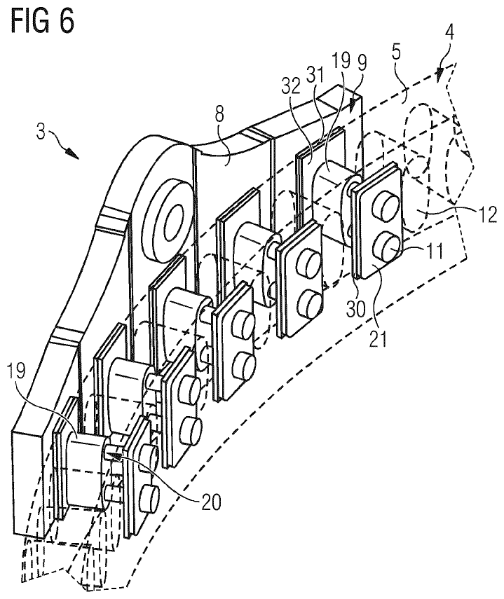

FIG. 6 shows a schematic second detail view of the lifting system of FIG. 4,

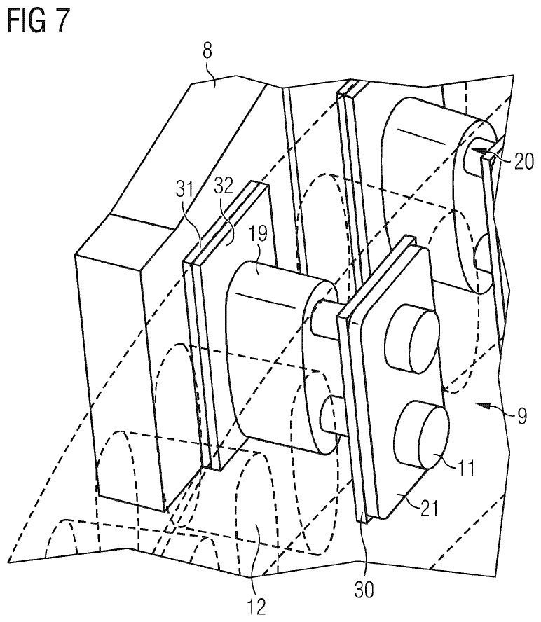

FIG. 7 shows a schematic detailed view of the lifting system of FIG. 6,

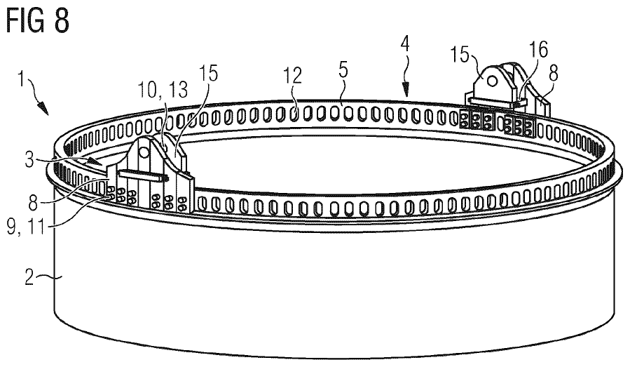

FIG. 8 shows a schematic perspective detail view of a lifting system with a male side of a wedge tower segment according to a second embodiment of the invention,

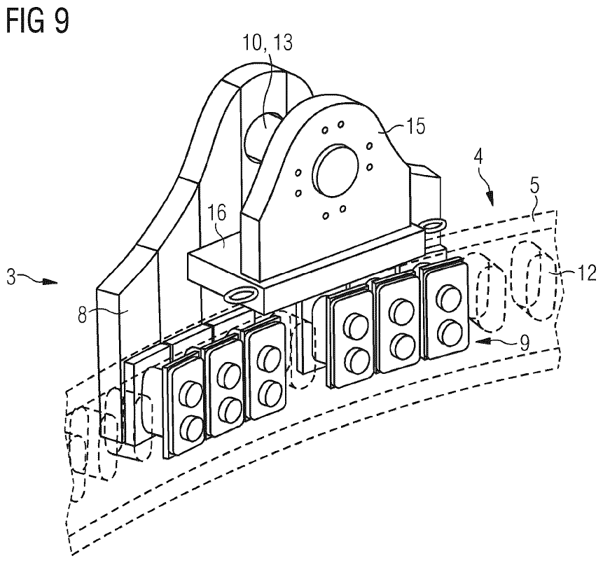

FIG. 9 shows a schematic detailed view of the lifting system of FIG. 8, and

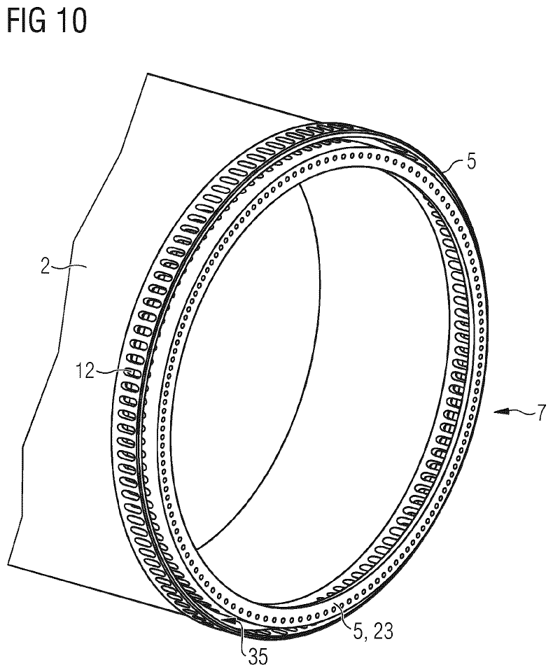

FIG. 10 shows a schematic perspective detail view of a female side of a wedge tower segment.

### DETAILED DESCRIPTION

In FIG. 1, a lifting system 1 with a standard tower segment 26 according to the prior art is shown in a schematic perspective view. At one side of the standard tower segment 26, two lifting profiles 28 of a first lifting assembly 3 are fixed. The lifting profiles 28 comprise a cylindrical interface body 13, wherein a spreader beam 27 of the first lifting assembly 3 is hinged to the cylindrical interface bodies 13. At the spreader beam 27, ropes are provided for connecting to a crane. A second lifting assembly 6 of the lifting system 1 is engaged with another side of the standard tower segment 26. The second lifting assembly 6 comprises an upending hook 29 for connecting to the crane.

FIG. 2 shows a schematic first detail view of the lifting system 1 of FIG. 1. In this figure, a part of the first lifting assembly 3 is shown. The lifting profile 28 of the first lifting assembly 3 is fixed to a flange 5 of the standard tower segment 26 by fixation means 9. The fixation means 9 comprise first fixation bolts 11. The cylindrical interface body 13 is attached to the lifting profile 28 between two side brackets of the lifting profile 28.

In FIG. 3, a schematic second detail view of the lifting system 1 of FIG. 1 is shown. In this figure, the second lifting assembly 6 is shown. The second lifting assembly 6 comprises a first holding plate 22 with a third dampening plate 33 in engagement with a face side 23 of another flange 5 of the standard tower segment 26. A second holding plate 24 of the second lifting assembly 6 is welded to the first holding plate 22 and carrying fourth dampening plates 34, which are engaged with an inside surface of the flange 5. The second lifting assembly 6 further comprises a hinge bore 25, wherein an upending hook 29 of the second lifting assembly 6 is hinged to the hinge bore 25.

FIG. 4 shows a schematic perspective detail view of a lifting system 1 with a male side 4 of a flange 5 of a wedge tower segment 2 according to a first embodiment of the invention. In this view, a first lifting assembly 3 of the lifting system 1 can be seen.

FIG. 5 shows a schematic first detail view of the lifting system 1 of FIG. 4. The first lifting assembly 3 comprises two first lifting brackets 8, each fastened to the male side 4 of the flange 5 of the wedge tower segment 2 by a plurality of first fixation means 9.

The first fixation means 9 comprises first fixation bolts 11, protruding though oval wedge slots 12 of the male side 4 of the flange 5. The first fixation bolts 11 are arranged in pairs in the wedge slots 12. This means that in each wedge slot 12 with a first fixation bolt 11, another first fixation bolt 11 is arranged. In other words, two fixation bolts 11 always protrude though the same wedge slot 12. At the first lifting bracket 8, two holding bars 17 are hinged. The holding bars 17 are arranged in parallel and connected by a cross bar 18. The holding bars 17 and the cross bar 18 can be welded together or configured as a monolithic part.

At an end side of the holding bars 17, which is facing away from the first lifting bracket 8, a first hinge interface 10 is arranged between the holding bars 17 for attaching an adapter of a crane, such as a hook, a rope or the like. The first hinge interface 10 comprises a cylindrical interface body 13 and a shoulder 14 for preventing a relative movement of the adapter of the crane. The first hinge interface 10 has an offset to the first lifting bracket 8 in a radial direction of the wedge tower segment 2. Therefore, a center of the first hinge interface 10 is closer to a center axis of the wedge tower segment 2 than to the first lifting bracket 8. In this embodiment, the offset is such that a position for the adapter of the crane at the first hinge interface 10 is in line with the flange 5. Thus, a torque on the first lifting bracket 8 and the fixation means 9, when lifting the wedge tower segment 2, can be reduced.

In FIG. 6, a schematic second detail view of the lifting system 1 of FIG. 4 is shown.

FIG. 7 shows a schematic detail view of FIG. 6. In these figures, a desired configuration of the first fixation means 9 is illustrated. The first fixation means 9 comprises a plurality of spacer blocks 19, each designed for filling one wedge slot 12. Thus, force transmission between these parts is improved. Each spacer block 19 has two bores 20, each configured for inserting a fixation bolt 11 of the first fixation means 9.

For clamping the flange 5 to the first lifting bracket 8, the first fixation means 9 comprises a first clamping plate 21 with a first dampening plate 30, interposed between the first clamping plate 21 and an inner side of the flange 5 of the male side 4, and a second clamping plate 31 with a second dampening plate 32, interposed between the second clamping plate 31 and an outer side of the flange 5 of the male side 4. By fastening the first fixation bolts 11, the flange 5 can be clamped between the first clamping plate 21 and the second clamping plate 31.

FIG. 8 shows a schematic perspective detail view of a lifting system 1 with a male side 4 of a flange 5 of a wedge tower segment 2 according to a second embodiment of the invention. In this view, a first lifting assembly 3 of the lifting system 1 can be seen.

FIG. 9 shows a schematic first detail view of the lifting system 1 of FIG. 4. The first lifting assembly 3 comprises two first lifting brackets 8, each fastened to the male side 4 of the flange 5 of the wedge tower segment 2 by a plurality of first fixation means 9.

The first fixation means 9 can be configured as described in the first embodiment of the invention regarding FIG. 4. As can be seen best in FIG. 9, the first lifting assembly 3 according to the second embodiment of the invention comprises an auxiliary bracket 15, extending parallel to the first lifting bracket 8 and connected to the first lifting bracket 8 by a retaining portion 16. The connections can be done by welds, screws or the like. The first hinge interface 10 comprises a cylindrical interface body 13, which is interposed between the first lifting bracket 8 and the auxiliary bracket 15 and attached thereto, e.g., by welds. The first hinge interface 10 has an offset to the first lifting bracket 8 in a radial direction of the wedge tower segment 2. Therefore, a center of the first hinge interface 10 is closer to a center axis of the wedge tower segment 2 than the first lifting bracket 8. In this embodiment, the offset is such that a position for the adapter of the crane at the first hinge interface 10 is in line with the flange 5. Thus, a torque on the first lifting bracket 8 and the fixation means 9, when lifting the wedge tower segment 2, can be reduced.

In FIG. 10, a female side 7 of a wedge tower segment 2 is shown in a schematic perspective detail view. The female side 7 comprises a plurality of oval wedge slots 12, circumferentially distributed over the female side 7. The female side 7 further comprises two flanges 5 with different diameters, coaxially arranged, wherein one of the flanges 5 constitutes a face side 23 of the female side 7. Between the flanges 5 of the female side 7, a circumferential reception 35 for receiving a matching part of the flange 5 of the male side 4 is provided. The male side 4 can be received such that each wedge slot 12 of the male side 4 is encompassed by two adjacent wedge slots 12 of the female side 7 and aligned with these wedge slots 12. In this configuration, the two wedge tower segments 2 can be fixed together. In an embodiment, the second lifting assembly 6 of FIG. 3 is used for the lifting system 1 according to embodiments of the invention for engaging the female side 7, the face side 23 and an inside wall of the flange 5 with the smaller diameter.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A lifting system for lifting a wedge tower segment of a wedge tower of a wind turbine, comprising a first lifting assembly for engaging with a male side of a flange of the wedge tower segment and a second lifting assembly for engaging with a female side of a flange of the wedge tower segment, wherein the first lifting assembly comprises a first lifting bracket with a plurality of first fixation means for fixing the first lifting bracket to the male side of the flange of the wedge tower segment and a first hinge interface for attaching the first lifting assembly to an adapter of a crane, wherein the first fixation means comprises a plurality of first fixation bolts for being inserted into wedge slots of the male side of the flange of the wedge tower segment for fixing the first lifting bracket to the flange,
wherein the first hinge interface has an offset to the first lifting bracket in a radial direction of the wedge tower segment.

2. The lifting system according to claim 1,
wherein the first hinge interface is configured such that in a state mounted to the male side of the flange, the first hinge interface is arranged in line with the flange at the male side.

3. The lifting system according to claim 1,
wherein the first hinge interface comprises a cylindrical interface body.

4. The lifting system according to claim 3,
wherein the cylindrical interface body has a shoulder and/or form-fit portion for keeping the adapter of the crane in line with the cylindrical interface body.

5. The lifting system according to claim 3,
wherein the cylindrical interface body is arranged between the first lifting bracket and an auxiliary bracket, wherein the auxiliary bracket comprises a retaining portion for retaining the auxiliary bracket against the first lifting bracket.

6. The lifting system according to claim 3,
wherein the cylindrical interface body, is arranged between two holding bars, wherein the two holding bars are connected to the first lifting bracket.

7. The lifting system according to claim 6,
wherein the two holding bars are mutually connected by a cross bar.

8. The lifting system according to claim 1,
wherein the first fixation means comprises a plurality of spacer blocks for infilling the wedge slots, wherein the plurality of spacer blocks comprise bores for the plurality of first fixation bolts.

9. The lifting system according to claim 1,
wherein the first fixation means comprises a plurality of first clamping plates for clamping the flange of the wedge tower segment in between the first lifting bracket and the plurality of first clamping plates.

10. The lifting system according to claim 1,
wherein the second lifting assembly comprises a first holding plate for engaging a face side of the female side of the flange of the wedge tower segment, a second holding plate for engaging an inside of the female side of the flange and a hinge bore for attaching the second lifting assembly to the crane.
